(19) United States
(12) Patent Application Publication
(10) Pub. No.: US 2012/0287822 A1
(43) Pub. Date: Nov. 15, 2012

(54) METHOD FOR PROVIDING INTER-PICONET MULTI-HOP MESH COMMUNICATION IN WIRELESS PERSONAL AREA NETWORK AND APPARATUS THEREOF

(75) Inventors: Young Ae JEON, Daejeon (KR); Seong-hee LEE, Daejeon (KR); Sangsung CHOI, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 13/560,793

(22) Filed: Jul. 27, 2012

Related U.S. Application Data
(63) Continuation of application No. 12/540,809, filed on Aug. 13, 2009.

(30) Foreign Application Priority Data
Aug. 13, 2008 (KR) 10-2008-0079464
Aug. 12, 2009 (KR) 10-2009-0074454

(51) Int. Cl. H04W 84/18

(52) U.S. Cl. 370/256; 370/255

(57) ABSTRACT

In the environment of a wireless personal area network (WPAN) with a plurality of piconets, to allow a tree-based routing service and an optimized routing service through repeatedly building parent-child piconets, an inter-piconet mesh communication device and method for providing a multi-hop communication function among a plurality of piconets is provided by defining a mesh sublayer between a frame convergence sublayer and a MAC sublayer and providing a mesh data service to the frame convergence sublayer through a mesh service access point, defining a mesh sublayer management entity between a device management entity and a MAC sublayer management entity and providing a mesh management service to a device management entity through a mesh sublayer management entity service access point.

### CROSS-REFERENCE TO RELATED APPLICATION

This application is a continuation application of U.S. patent application Ser. No. 12/540,809, filed on Aug. 13, 2009, the disclosure of which is herein incorporated by reference in its entirety. The U.S. patent application Ser. No. 12/540,809 claims priority to and the benefit of Korean Patent Application No. 10-2008-0079464 and 10-2009-0074454 filed in the Korean Intellectual Property Office on Aug. 13, 2008 and Aug. 12, 2009, respectively, the entire contents of which are incorporated herein by reference.

### BACKGROUND OF THE INVENTION

(a) Field of the Invention

The present invention relates to a method for providing inter-piconet multi-hop mesh communication in a wireless personal area network and an apparatus thereof.

(b) Description of the Related Art

A wireless personal area network (WPNA) wirelessly connects audio/video devices, computers, and peripherals within 10 meters of short distance, and it supports communication between small multimedia devices with low power consumption and portability, thereby supporting various services.

In general, the WPAN starts by connecting at least two devices, that is, by forming a piconet.

In this instance, the devices forming the piconet forming the WPAN communicate with each other only by a single hop scheme, and hence, when the WPAN is formed by a plurality of piconets, the devices included in different piconets cannot communicate with each other even though they have a physical link between them.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an inter-piconet mesh network communication apparatus and method in the WPAN for providing a multi-hop communication function between a plurality of piconets.

An exemplary embodiment of the present invention provides a method for providing inter-piconet multi-hop mesh communication in a wireless personal area network (WPAN) including: searching a network existing near a device, and determining whether there is a mesh network operating near the device according to the search result; when there is no mesh network, determining parameters relating to a primitive for the start of a new mesh network as a mesh piconet coordinator of the new mesh network; and transmitting a beacon frame generated based on the parameter to a plurality of devices near the device, and controlling the plurality of devices to communicate according to the single hop method based on the beacon frame.

The method further includes associating the mesh network when the mesh network exists.

The search result includes a piconet ID of the mesh network.

The parameter includes a mesh ID, a tree ID block, and a beacon source ID.

Another embodiment of the present invention provides a method for providing inter-piconet multi-hop mesh communication in a wireless personal area network (WPAN) including: searching a mesh network existing near a device; selecting a parent piconet to be associated by the device based on scan information corresponding to the search result; and associating the parent piconet and receiving a tree ID block from a coordinator of the parent piconet.

The mesh network includes a plurality of piconets, and the scan information includes a mesh ID of the mesh network, piconet ID's of the plurality of piconets, and an operation channel of the mesh network.

The selecting includes selecting the parent piconet with reference to a number of hops to the coordinator, a link state, and a channel time resource to be allocated.

The method further includes generating a child piconet of the parent piconet.

The generating of a child piconet includes: initializing mesh parameters including a piconet ID of the child piconet and an operation channel; generating a beacon based on the mesh parameter; and transmitting the beacon to a device that is not associated to the mesh network through the operation channel.

The generating of a child piconet further includes requesting channel time allocation from the coordinator; and receiving an allocated channel time from the coordinator, and the transmitting of the beacon includes transmitting the beacon through the operation channel during the allocated channel time.

### BRIEF DESCRIPTION OF THE DRAWINGS

FIG. 1 shows a first example of a schematic diagram of a piconet forming a WPAN.

FIG. 2 shows a second example of a schematic diagram of a piconet forming a WPAN.

FIG. 3 shows a third example of schematic diagram of a piconet forming a WPAN.

FIG. 4 shows a mesh network communication apparatus according to an exemplary embodiment of the present invention.

FIG. 5 shows a method for starting a mesh network according to an exemplary embodiment of the present invention.

FIG. 6 shows a message flow when a mesh network according to an exemplary embodiment of the present invention starts.

FIG. 7 shows a method for forming a tree of a mesh network according to an exemplary embodiment of the present invention.

FIG. 8 shows a method for generating a child piconet according to an exemplary embodiment of the present invention.

FIG. 9 shows a message flow when a tree of a mesh network according to an exemplary embodiment of the present invention is formed.

FIG. 10 shows a configuration of a piconet configuring a WPAN according to an exemplary embodiment of the present invention.

FIG. 11 shows a structure of a data frame configured by a mesh device according to an exemplary embodiment of the present invention.

FIG. 12 shows a method for setting a parameter of a PIB according to an exemplary embodiment of the present invention.

FIG. 13 shows a method for requesting a parameter of a PIB according to an exemplary embodiment of the present invention.

FIG. 14 shows a method for resetting a parameter of a PIB according to an exemplary embodiment of the present invention.

FIG. 15 shows a message flow when dissociating from a mesh network according to an exemplary embodiment of the present invention.

FIG. 16 shows a message when dissociating from a mesh network according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

An inter-piconet multi-hop mesh communication apparatus and method in a wireless personal area network according to an exemplary embodiment of the present invention will now be described with reference to accompanying drawings.

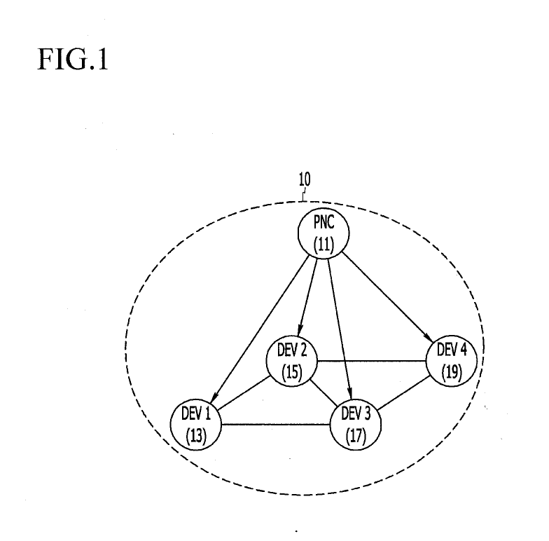

Referring to FIG. 1 to FIG. 3, various forms of the piconet forming the wireless personal area network (WPAN) will now be described.

FIG. 1 shows a first example of a schematic diagram of a piconet forming a WPAN,

In this instance, the WPAN includes a piconet.

As shown in FIG. 1, the first piconet 10 includes a piconet coordinator (PNC) and a plurality of devices (DEV) including a first device (DEV 1) 13, a second device (DEV 2) 15, a third device (DEV 3) 17, and a fourth device (DEV 4) 19.

The piconet coordinator (PNC) 11 is randomly selected from a plurality of devices included in the first piconet 10, and the device selected as the piconet coordinator (PNC) 11 controls basic timing of the first piconet 10 by using a beacon frame.

The piconet coordinator (PNC) 11 and the devices 13, 15, 17, and 19 included in the first piconet 10 communicate with each other according to the single hop method by using beacon information included in the beacon frame. For example, the first device 13 can communicate by the single hop method using a link between the first device 13 and the third device 17, and it cannot communicate with the third device 17 according to the multi-hop method using a link between the first device 13 and the second device 15 and a link between the second device 15 and the third device 17 via the second device 15.

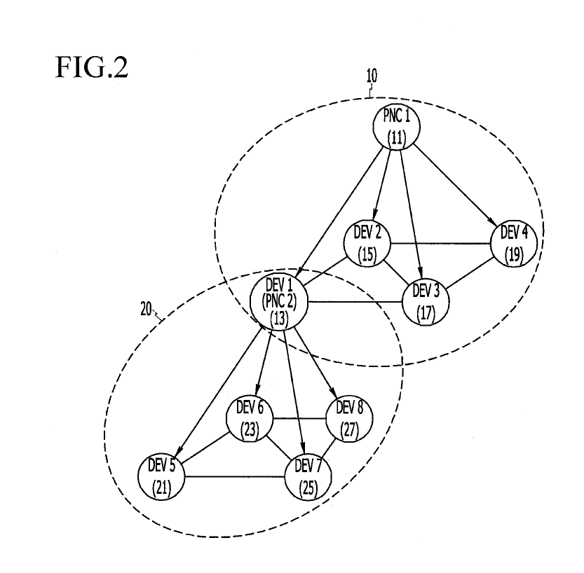

FIG. 2 shows a second example of a schematic diagram of a piconet forming a WPAN.

In this instance, the WPAN includes two piconets coexisting on the same channel.

As shown in FIG. 2, the first piconet 10 includes a first piconet coordinator (PNC 1) 11, a first device (DEV 1) 13, a second device (DEV 2) 15, a third device (DEV 3) 17, and a fourth device (DEV 4) 19.

The second piconet 20 includes a second piconet coordinator (PNC 2) 13, a fifth device (DEV 5) 21, a sixth device (DEV 6) 23, a seventh device (DEV 7) 25, and an eighth device (DEV 8) 27.

In this instance, the first piconet 10 corresponds to a parent piconet for the second piconet 20, the second piconet 20 corresponds to a child piconet for the first piconet 10, and the first device 13 from among the devices 13, 15, 17, and 19 included in the first piconet 10, the parent piconet functions as a piconet coordinator of the second piconet 20, the child piconet.

In this case, the first piconet controller 11 and the devices 13, 15, 17, and 19 included in the first piconet 10, the parent piconet communicate according to the single hop method, and the second piconet controller 13 and the devices 21, 23, 25, and 27 included in the second piconet 20, the child piconet communicate according to the single hop method.

The piconet coordinator 13 of the second piconet 20, the child piconet communicates with the devices 21, 23, 25, and 27 included in the second piconet 20 according to the single hop method, and it can communicate with the devices 11, 15, 17, and 19 included in the first piconet 10, the parent piconet according to the single hop method.

However, the devices 21, 23, 25, and 27 other than the second piconet controller 13 in the second piconet 20 cannot communicate with the devices 11, 15, 17, and 19 belonging to a different piconet that is the first piconet 10 according to the multi-hop method under relay by the second piconet coordinator 13 as well as the single hop method.

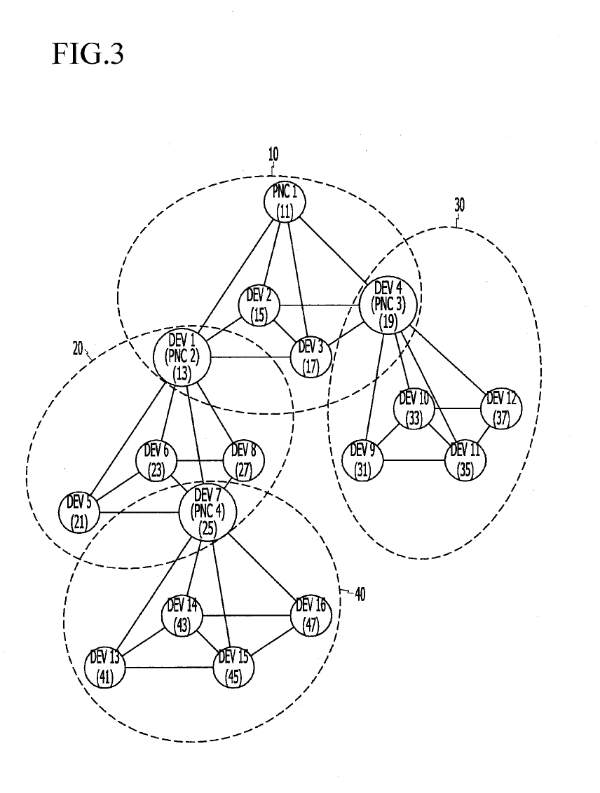

FIG. 3 shows a third example of a schematic diagram of a piconet forming a WPAN.

In this instance, the WPAN includes a plurality of piconets coexisting on the same channel.

As shown in FIG. 3, the first piconet 10 includes a first piconet coordinator (PNC 1) 11, a first device (DEV 1) 13, a second device (DEV 2) 15, a third device (DEV 3) 17, and a fourth device (DEV 4) 19.

The second piconet 20 includes a second piconet coordinator (PNC 2) 13, a fifth device (DEV 5) 21, a sixth device (DEV 6) 23, a seventh device (DEV 7) 25, and an eighth device (DEV 8) 27.

The third piconet 30 includes a third piconet coordinator (PNC 3) 19, a ninth device (DEV 9) 31, a tenth device (DEV 10) 33, an eleventh device (DEV 11) 35, and a twelfth device (DEV 12) 37.

The fourth piconet 40 includes a fourth piconet coordinator (PNC 4) 25, a thirteenth device (DEV 13) 41, a fourteenth device (DEV 14) 43, a fifteenth device (DEV 15) 45, and a sixteenth device (DEV 16) 47.

In this instance, the first piconet 10 corresponds to a parent piconet for the second piconet 20 and the third piconet 30, the second piconet 20 and the third piconet 30 correspond to child piconet for the first piconet 10, the first device 13 from among the devices 13, 15, 17, and 19 included in the first piconet 10 functions as a piconet coordinator of the second piconet 20, and the fourth device 19 from among the devices 13, 15, 17, and 19 included in the first piconet 10 functions as a piconet coordinator of the third piconet 30.

Also, the second piconet 20 corresponds to a parent piconet for the fourth piconet 40, the fourth piconet 40 corresponds to a child piconet for the second piconet 20, and the seventh device 25 from among the devices 21, 23, 25, and 27 included in the second piconet 20 functions as a piconet coordinator for the fourth piconet 40.

In this case, the devices 13, 15, 17, and 19 included in the first piconet 10 as well as the first piconet controller 11 communicate with each other according to the single hop method, and the devices 21, 23, 25, and 27 included in the second piconet 20, the child piconet as well as the second piconet controller 13 communicate with each other according to the single hop method. Further, the devices 31, 33, 35, and 37 included in the third piconet 30 as well as the third piconet controller 19 communicate with each other according to the single hop method, and the devices 41, 43, 45, and 47 included in the fourth piconet 40 as well as the fourth piconet controller 25 communicate with each other according to the single hop method.

However, the piconet coordinator 13 of the second piconet 20 can communicate with the devices 21, 23, 25, and 27 included in the second piconet 20 and the devices 11, 15, 17, and 19 included in the first piconet 10 according to the single hop method, and the devices 21, 23, 25, and 27 included in the second piconet 20 and the devices 11, 15, 17, and 19 included in the first piconet 10 cannot communicate with devices belonging to another piconet according to the multi-hop method as well as the single hop method.

In addition, the piconet coordinator 19 of the third piconet 30 can communicate with the devices 31, 33, 35, and 37 included in the third piconet 30 and the devices 11, 13, 15, and 17 included in first piconet 10 according to the single hop method, and the devices 31, 33, 35, and 37 included in the third piconet 30 and the devices 11, 13, 15, and 17 included in the first piconet 10 cannot communicate with devices belonging to another piconet according to the multi-hop method as well as the single hop method.

Also, the piconet coordinator 25 of the fourth piconet 40 can communicate with the devices 41, 43, 45, and 47 included in the fourth piconet 40 and the devices 13, 21, 23, and 27 included in the second piconet 20 according to the single hop method, and the devices 41, 43, 45, and 47 included in the fourth piconet 40 and the devices 13, 21, 23, and 27 included in the second piconet 20 cannot communicate with devices belonging to another piconet according to the multi-hop method as well as the single hop method.

As described, since the single hop communication was possible in the single piconet conventionally, communication with members belonging to a different piconet was impossible.

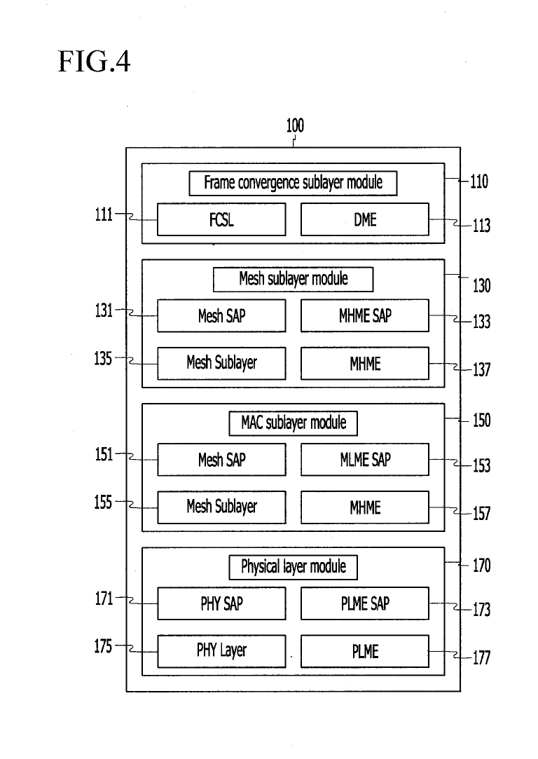

A mesh network communication apparatus according to an exemplary embodiment of the present invention will now be described with reference to FIG. 4.

FIG. 4 shows a mesh network communication apparatus for an inter-piconet multi-hop mesh communication in a WPAN.

As shown in FIG. 4, the mesh network communication apparatus (hereinafter, it may be called a device) 100 includes a frame convergence sublayer module 110, a mesh sublayer module 130, a MAC sublayer module 150, and a physical layer module 170.

The frame convergence sublayer module 110 includes a frame convergence sublayer (FCSL) 111 and a device management entity (DME).

The mesh sublayer module 130 includes a mesh service access point (mesh SAP) 131, a mesh sublayer management entity service access point (MHME SAP) 133, a mesh sublayer 135 and a mesh sublayer management entity (MHME) 137.

The mesh SAP 131 defines a primitive relating to transmitting/receiving of asynchronous data and a primitive relating to transmitting/receiving of isochronous data. In this instance, the types and contents of the primitives defined by the mesh SAP 131 can follow Table 1.

TABLE 1

| Types | Contents |
|---|---|
| MESH-ASYNC-DATA.request | Request asynchronous data |
| | transmission |
| MESH-ASYNC-DATA.confirm | Notify transmission request result of |
| | asynchronous data |
| MESH-ASYNC-DATA.indication | Notify of receipt of asynchronous |
| | data |
| MESH-ISOCH-DATA.request | Request isochronous data |
| | transmission |
| MESH-ISOCH-DATA.confirm | Notify transmission request result of |
| | isochronous data |
| MESH-ISOCH-DATA.indication | Request receipt of isochronous data |

The MH ME SAP 133 defines a primitive relating to the mesh network. In this instance, the types and contents of the primitive defined by the MHME SAP 133 can follow Table 2.

TABLE 2

| Types | Contents |
|---|---|
| MHME-SET.request | Request to set specific parameter |
| | of PIB with a specific value |
| MHME-SET.confirm | Notify request result of |
| | MHME-SET.request |
| MHME-GET.request | Request specific parameter value |
| | of PIB |
| MHME-GET.confirm | Notify request result of |
| | MHME-GET.request |
| MHME-RESET.request | Request to maintain specific |
| | parameter of PIB at default value |
| | or current value |
| MHME-RESET.confirm | Notify request result of |
| | MHME-RESET.request |
| MHME-SCAN.request | Request to check existence of mesh |
| | network |
| MHME-SCAN.confirm | Notify existence check request |
| | result of mesh network |
| MHME-SCAN.indication | Find mesh network through beacon |
| | analysis of another device |
| MHME-START.request | Start mesh network or request to |
| | generate and transmit beacon |
| MHME-START.confirm | Notify request result of |
| | MHME-START.request |
| MHME-STOP.request | MPNC requests to stop mesh |
| | network |
| MHME-STOP.confirm | Notify request result of |
| | MHME-STOP.request |
| MHME-ASSOCIATE.request | Select parent MPNC and request to |
| | associate mesh network |
| MHME-ASSOCIATE.confirm | Notify request result of |
| | MHME-ASSOCIATE.request |
| MHME-ASSOCIATE.indication | Notify parent MPNC of association |
| | state of child MPNC |
| MHME-DISASSOCIATE.request | Request to dissociate from mesh |
| | network |
| MHME-DISASSOCIATE.confirm | Notify request result of |
| | MHME-DISASSOCIATE.request |
| MHME-DISASSOCIATE.indication | Notify when receiving dissociation |
| | request by parent MPNC from |
| | mesh network |
| MHME-TREEID-ASSIGN.request | Child MPNC requests tree ID from |
| | parent MPNC |
| MHME-TREEID-ASSIGN.confirm | Notify requesy result of |
| | MHME-TREEID-ASSIGN.request |
| MHME-TREEID-ASSIGN.indication | Notify child MPNC of allocation |
| | result |

In this instance, the PIB is a personal area network information base, and MPNC is a mesh piconet coordinator.

The mesh sublayer 135 configures a mesh instruction frame by applying the request by the MHME 137 so as to provide a mesh routing service. In this instance, the types of instruction frames and data frames configured by the mesh sublayer 135 can follow Table 3.

TABLE 3

| Types | Description |
|---|---|
| TREEID request | Tree ID request frame |
| TREEID assignment | Tree ID assignment frame |
| Server notification | Server notification frame |
| Server inquiry | Server inquiry frame |
| Link state request | Link state request frame |
| Link state registration | Link state registration frame |
| Route discovery | Route discovery frame |
| Route notification | Route notification frame |
| Route formation | Route formation frame |
| Route error | Route error notification frame |
| Mesh data frame | Mesh data frame not including |
| | LLC/SNAP header |
| Mesh LLC/SNAP data frame | Mesh data frame including LLC/SNAP |
| | header |

In Table 3, LLC is an abbreviation for logical link control and SNAP is an abbreviation for sub-network access point.

The tree ID request frame is used when the child MPNC requests a tree ID (TREEID) and a tree ID block from the parent MPNC, and the tree ID allocation frame is used when the parent MPNC assigns a tree ID (TREEID) and a tree ID block to the child MPNC.

Also in Table 3, the server notification frame is used when the MPNC provides server information to at least one MPNC, the server inquiry frame is used when the child MPNC request server information from the parent MPNC, the link state request frame is used when the parent MPNC functioning as a topology server attempts to check the link state of the child MPNC's, and the link state registration frame is used when the child MPNC notifies the parent MPNC functioning as a topology server of link state information.

In addition in Table 3, the route discovery frame is used when the source MPNC finds the optimized route, the route notification frame is used when the parent MPNC functioning as a topology server knows the optimized destination MPNC according to the received route discovery frame and notifies the optimized destination MPNC of the route, and the route formation frame is used to set the route to the source MPNC when the MPNC receives the route notification frame.

The MHME 137 provides a tree-based routing service based on a tree ID assigned to the tree structure configured as a parent-child piconet and an optimized routing service for discovering the optimized route by using the MPNC of the parent piconet functioning as a topology server.

The MAC sublayer module 150 includes a MAC service access point (MAC SAP) 151, a MAC sublayer management entity service access point (MLME SAP) 153, a MAC sublayer 155, and a MAC sublayer management entity (MLME) 157.

The MLME SAP 153 further defines a primitive relating to mesh information other than prior primitives based on IEEE 802.15.3 MAC. In this instance, the types and contents of the primitives defined by the MLME SAP 153 can follow Table 4.

TABLE 4

| Types | Contents |
|---|---|
| MLME-MESH-CAPABILITY.request | Notify MAC sublayer of mesh |
| | information |
| MLME-MESH-CAPABILITY.confirm | Notify request result of |
| | MLME-MESH- |
| | CAPABILITY.request |
| MLME-MESH-CAPABILITY.indication | Notify receipt of mesh |
| | information |

The physical layer module 170 includes a physical layer service access point (PHY SAP) 171, a physical layer management entity service access point (PLME SAP) 173, a physical layer (PHY layer) 175, and a physical layer management entity (PLME) 177.

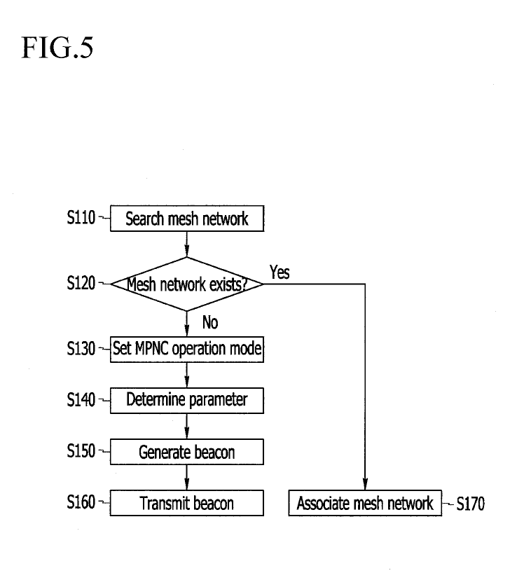

Referring to FIG. 5, a method for a mesh network communication apparatus (hereinafter, a device) 100 to start a mesh network for an inter-piconet multi-hop communication in a WPAN according to an exemplary embodiment of the present invention will now be described.

FIG. 5 shows a method for starting a mesh network according to an exemplary embodiment of the present invention.

As shown in FIG. 5, the device 100 searches the mesh network existing near the device 100 (S110).

The device 100 determines whether there is a mesh network operating near the device 100 according to the search result (S120).

When there is no mesh network, the device 100 sets the MPNC operation mode so that the device 100 may be operable as a mesh piconet coordinator (MPNC) of the mesh network (S130).

The device 100 performs a mesh initialization process for determining parameters relating to primitive for the start of the mesh network (S140). The parameters include a mesh ID, a tree ID block, and a beacon source ID (S140).

The device 100 generates a beacon based on the determined parameters (S150).

The device 100 transmits the generated beacon (S160).

When there is a mesh network, the device 100 associates the corresponding mesh network (S170).

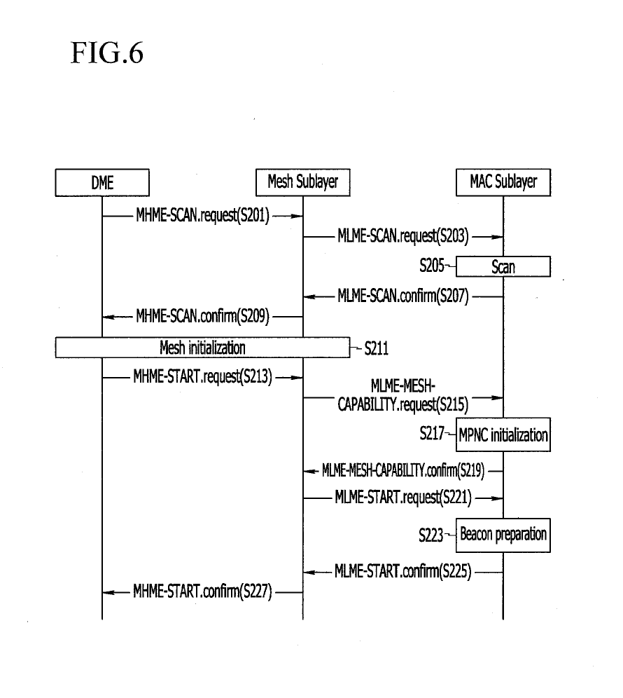

Referring to FIG. 6, a message flow in the mesh network communication device 100 according to an exemplary embodiment of the present invention when the same device 100 starts the mesh network according to FIG. 5 will now be described. Here, the device 100 can follow FIG. 4.

FIG. 6 shows a message flow when a mesh network according to an exemplary embodiment of the present invention starts.

As shown in FIG. 6, the DME 113 of the device 100 transmits a MHMH-SCAN.request primitive for requesting to check the existence state of the mesh network to the mesh sublayer 135 (S201).

The mesh sublayer 135 transmits the MLMH-SCAN.request primitive to the MAC sublayer 155 according to the received MHMH-SCAN.request primitive (S203).

The MAC sublayer 155 performs a scan process according to the received MLMH-SCAN.request primitive (S205).

The MAC sublayer 155 transmits the MLME-SCAN.confirm primitive including a mesh ID, a tree ID block, and a piconet ID of the mesh network operable near the device 100 to the mesh sublayer 135 according to the scan result (S207).

The mesh sublayer 135 transmits the MHME-SCAN.confirm primitive including information on the mesh network operable near the device 100 to the DME 113 based on the received MLME-SCAN.confirm primitive (S209).

The DME 113 and the mesh sublayer 135 performs a mesh initialization process for determining parameters to be needed in a MHME-START.request primitive which includes a mesh ID, tree ID, and a beacon source IDwhen it is determined that there is no mesh network operating near the device 100 based on the MHME-SCAN.confirm primitive (S211). In this instance, when there is a mesh network that is searched in the scan process, the device 100 can associate the corresponding mesh network.

The DME 113 transmits the MHME-START.request primitive to the mesh sublayer 135 so as to start the mesh network (S213).

The mesh sublayer 135 transmits the MLME-MESH-CAPABILITY.request primitive including the parameters relating to the mesh network to the MAC sublayer 155 according to the received MHME-START.request primitive (S215).

The MAC sublayer 155 starts the mesh piconet coordinator (MPNC) initialization process to set the MPNC operation mode and initialize the parameter according to the received MLME-MESH-CAPABILITY.request primitive (S217).

The MAC sublayer 155 transmits the MLME-MESH-CAPABILITY.confirm primitive to the mesh sublayer 135 according to the result caused by the mesh piconet coordinator start process (S219).

The mesh sublayer 135 transmits the MLME-START.request primitive to the MAC sublayer 155 so that the MAC sublayer 155 may start the piconet according to the received MLME-MESH-CAPABILITY.confirm primitive (S221).

The MAC sublayer 155 performs a beacon preparation process according to the received MLME-START.request primitive (S223).

The MAC sublayer 155 transmits the MLME-START.confirm primitive to the mesh sublayer 135 according to the beacon preparation process result (S225).

The mesh sublayer 135 transmits the MHME-START.confirm primitive to the DME 113 according to the received MLME-START.confirm primitive to notify the DME 113 of the beacon preparation process result (S227).

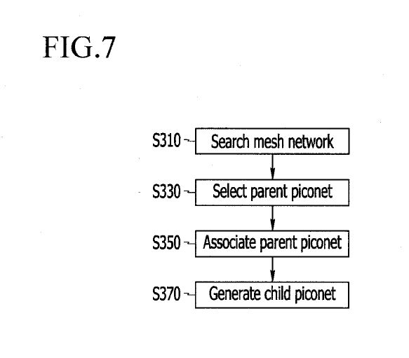

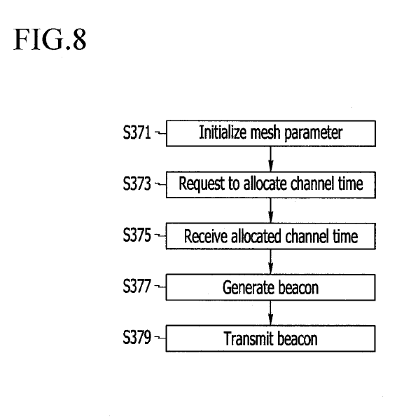

Referring to FIG. 7 and FIG. 8, a method for the mesh network communication device (hereinafter, device) 100 according to an exemplary embodiment of the present invention to form a tree of the mesh network for an inter-piconet multi-hop communication will now be described.

FIG. 7 shows a method for forming a tree of a mesh network according to an exemplary embodiment of the present invention.

As shown in FIG. 7, the device 100 searches a mesh network near the device 100 (S310). Here, the device 100 can acquire scan information including the parameter including a mesh ID of the mesh network, a tree ID block, a piconet ID, and an operation channel according to the mesh network search result.

The device 100 selects a parent piconet to associate based on the mesh network search result that is scan information (S330). In this instance, the device 100 can select a parent piconet to associate with reference to the number of hops to the route, the link state, and the channel time resource to be assigned based on the scan information.

The device 100 associates the selected parent piconet (S350). In this instance, the device 100 can be assigned a tree ID block from the mesh piconet coordinator of the corresponding parent piconet when succeeding in associating the corresponding parent piconet.

Upon receiving a tree ID block, the device 100 generates a child piconet of the parent piconet, the mesh piconet coordinator (S370). A method for generating the child piconet will be described with reference to FIG. 8.

FIG. 8 shows a method for generating a child piconet according to an exemplary embodiment of the present invention.

As shown in FIG. 8, the device 100 initializes the mesh parameters including a mesh ID, a tree ID block, and an operation channel so that the device 100 may operate as mesh piconet coordinator of the child piconet (S371).

The device 100 requests channel time allocation (CTA) from the mesh piconet coordinator of the parent piconet (S373).

The device 100 receives an allocated channel time from the mesh piconet coordinator of the parent piconet (S375).

The device 100 generates a beacon based on the initialized mesh parameter and the allocated channel time (S377).

The device 100 transmits the generated beacon through the initialized operation channel (S379). The device 100 transmits the beacon to the neighboring devices that is not registered to the mesh network so that the neighboring devices may associate the mesh network.

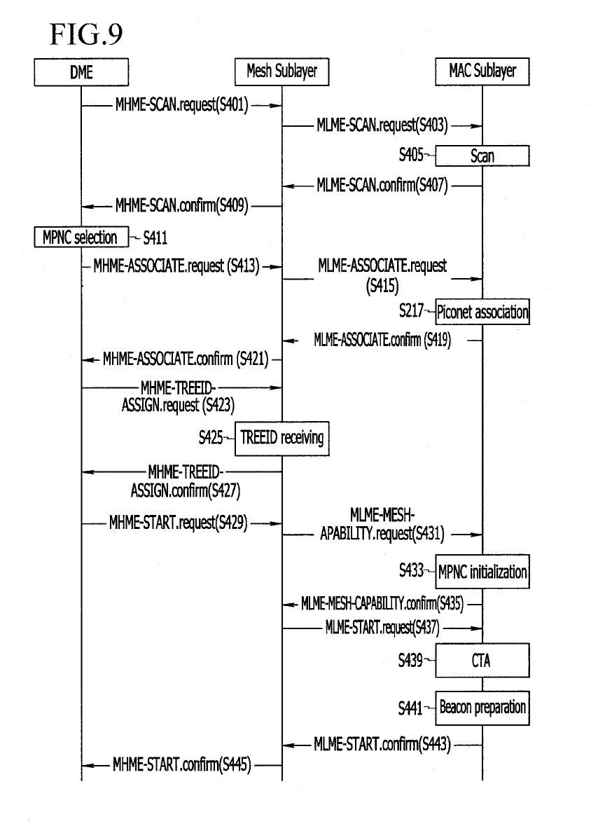

Referring to FIG. 9, a message flow in the mesh network communication device (hereinafter, device) 100 when the device 100 forms a tree of the mesh network according to FIG. 7 and FIG. 8 will now be described. In this instance, the device 100 can follow FIG. 4.

FIG. 9 shows a message flow when a tree of a mesh network according to an exemplary embodiment of the present invention is formed.

As shown in FIG. 9, the DME 113 of the device 100 transmits the MHME-SCAN.request primitive for requesting the existence state of the mesh network to the mesh sublayer 135 so as to find the mesh network operating near the device 100 (S401).

The mesh sublayer 135 transmits the MLMH-SCAN.request primitive to the MAC sublayer 155 according to the received MHMH-SCAN.request primitive (S403).

The MAC sublayer 155 performs a scan process according to the received MLMH-SCAN.request primitive (S405).

The MAC sublayer 155 transmits the MLME-SCAN.confirm primitive including the parameters including a mesh ID, a tree ID block, a piconet ID of the mesh network operable near the device 100, and an operation channel to the mesh sublayer 135 according to the scan result (S407).

The mesh sublayer 135 transmits the MHME-SCAN.confirm primitive including information on the mesh network operating near the device 100 to the DME 113 based on the received MLME-SCAN.confirm primitive (S409).

The DME 113 selects the mesh piconet coordinator (MPNC) which the most suitable for association with reference to the number of hops to the route, the link state, and the channel time resource to be assigned based on the received MHME-SCAN.confirm primitive (S411).

The DME 113 transmits the MHME-ASSOCIATE.request primitive for requesting association to the mesh network to the mesh sublayer 135 (S413).

The mesh sublayer 135 transmits the MLME-ASSOCIATE.request primitive to the MAC sublayer 155 according to the received MHME-ASSOCIATE.request primitive (S415).

The MAC sublayer 155 performs a piconet association process according to the received MLME-ASSOCIATE.request primitive (S417).

The MAC sublayer 155 transmits the MLME-ASSOCIATATE.confirm primitive to the mesh sublayer 135 according to the piconet association process result (S419).

The mesh sublayer 135 transmits the MHME-ASSOCIATATE.confirm primitive including the piconet association result to the DME 113 according to the received MLME-ASSOCIATATE.confirm primitive (S421).

The DME 113 transmits the MHME-TREEID-ASSIGN.request primitive for requesting a tree ID block from the parent MPNC by the child MPNC to the mesh sublayer 135 (S423).

The mesh sublayer 135 receives a tree ID block from the parent MPNC according to the received MHME-TREEID-ASSIGN.request primitive (S425).

The mesh sublayer 135 transmits the MHME-TREEID-ASSIGN.confirm primitive including the received tree ID to the DME 113 (S427).

The DME 113 transmits the MHME-START.request primitive for starting the mesh network to the mesh sublayer 135 in order to start the child piconet generation process (S429).

The mesh sublayer 135 transmits the MLME-MESH-CAPABILITY.request primitive including the mesh parameters including a mesh ID and a tree ID block to the MAC sublayer 155 according to the received MHME-START.request primitive (S431).

The MAC sublayer 155 initializes the mesh parameters (i.e., the MPNC initialization process) so that the device may be operable as a child MPNC according to the received MLME-MESH-CAPABILITY.request primitive (S433).

The MAC sublayer 155 transmits the MLME-MESH-CAPABILITY.confirm primitive to the mesh sublayer 135 according to the MPNC initialization result (S435).

The mesh sublayer 135 transmits the MLME-START.request primitive to the MAC sublayer 155 according to the received MLME-MESH-CAPABILITY.confirm primitive (S437).

The MAC sublayer 155 performs a channel time allocation (CTA) process according to the received MLME-START.request primitive (S439).

The MAC sublayer 155 performs a beacon preparation process according to the received MLME-START.request primitive (S441).

The MAC sublayer 155 transmits the MLME-START.confirm primitive to the mesh sublayer 135 according to the beacon preparation process result (S443).

The mesh sublayer 135 transmits the MHME-START.confirm primitive to the DME 113 according to the received MLME-START.confirm primitive to notify the DME 113 of the beacon preparation process result (S445).

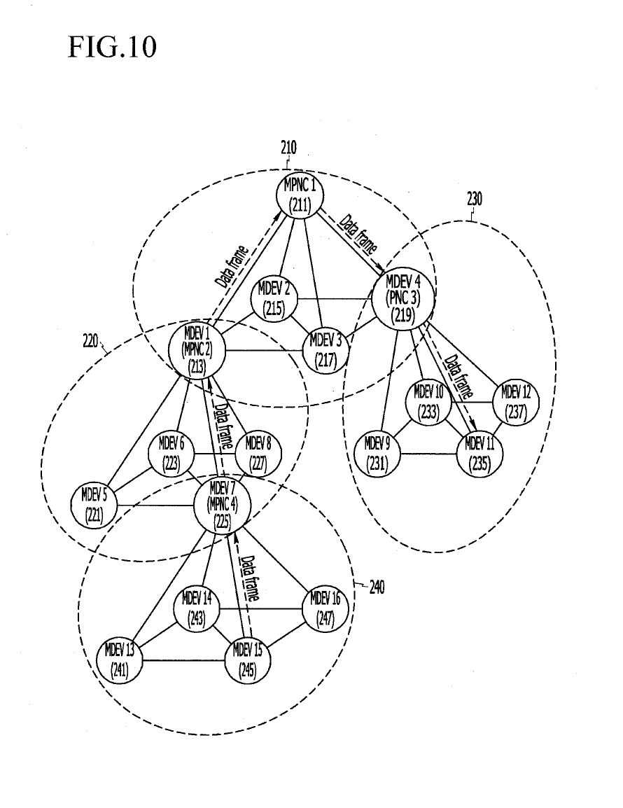

Referring to FIG. 10, a configuration of a piconet for configuring the wireless personal area network (WPAN) according to an exemplary embodiment of the present invention will now be described.

FIG. 10 shows a configuration of a piconet configuring a WPAN according to an exemplary embodiment of the present invention.

The WPAN is configured by 4 piconets existing on the same channel.

As shown in FIG. 10, the first piconet 210 includes a first mesh piconet coordinator (MPNC 1) 211 and a plurality of mesh devices (MDEV) including a first mesh device (MDEV 1) 213, a second mesh device (MDEV 2) 215, a third mesh device (MDEV 3) 217, and a fourth mesh device (MDEV 4) 219.

The second piconet 220 includes a second mesh piconet coordinator (MPNC 2) 213, a fifth mesh device (MDEV 5) 221, a sixth mesh device (MDEV 6) 223, a seventh mesh device (MDEV 7) 225, and an eighth mesh device (MDEV 8) 227.

The third piconet 230 includes a third mesh piconet coordinator (MPNC 3) 219, a ninth mesh device (MDEV 9) 221, a tenth mesh device (MDEV 10) 233, an eleventh mesh device (MDEV 11) 235, and a twelfth mesh device (MDEV 12) 237.

The fourth piconet 240 includes a fourth mesh piconet coordinator (MPNC 4) 225, a thirteenth mesh device (MDEV 13) 241, a fourteenth mesh device (MDEV 14) 243, a fifteenth mesh device (MDEV 15) 245, and a sixteenth mesh device (MDEV 16) 247.

In this instance, the first piconet 210 corresponds to a parent piconet for the second piconet 220 and the third piconet 230, the second piconet 220 and the third piconet 230 correspond to a child piconet for the first piconet 210, the first mesh device 213 from among the mesh devices 213, 215, 217, and 219 included in the first piconet 210 functions as a mesh piconet coordinator (MPNC 2) of the second piconet 220, and the fourth mesh device 219 from among the mesh devices 213, 215, 217, and 219 included in the first piconet 210 functions as a mesh piconet coordinator (MPNC 3) of the third piconet 230.

Also, the second piconet 220 corresponds to a parent piconet for the fourth piconet 240, the fourth piconet 240 corresponds to a child piconet for the second piconet 220, and the seventh mesh device 225 from among the mesh devices 221, 223, 225, and 227 included in the second piconet 220 functions as a mesh piconet coordinator (MPNC 4) of the fourth piconet 230.

A method for the fifteenth mesh device (MDEV 15) 245 of the fourth piconet 240 to transmit data to the eleventh mesh device (MDEV 11) 235 of the third piconet 230 will now be described.

When the fifteenth mesh device (MDEV 15) 245 attempts to transmit data to the eleventh mesh device (MDEV 11) 235, the source mesh device that is the fifteenth mesh device (MDEV 15) 245 configures a data frame including a mesh header and data to be transmitted to the destination mesh device that is the eleventh mesh device (MDEV 11) 235. In this instance, the fifteenth mesh device (MDEV 15) 245 sets the source tree ID (source TREEID) and the source ID (Source ID) as values corresponding to the source mesh device at the mesh header, and sets the destination tree ID (Destination TREEID) and the destination ID (Destination ID) as values corresponding to the destination mesh device.

The fifteenth mesh device (MDEV 15) 245 transmits a data frame to the fourth mesh piconet coordinator (MPNC 4) 225 that is a mesh piconet coordinator of the fourth piconet 240 including the source mesh device.

The fourth mesh piconet coordinator (MPNC 4) 225 analyzes the received data frame to transmit the data frame to the second mesh piconet coordinator (MPNC 2) 213 that is a mesh piconet coordinator of the second piconet 220 including the fourth mesh piconet coordinator (MPNC 4) 225.

The second mesh piconet coordinator (MPNC 2) 213 analyzes the received data frame to transmit the data frame to the first mesh piconet coordinator (MPNC 1) 211 that is a mesh piconet coordinator of the first piconet 210 including the second mesh piconet coordinator (MPNC 2) 213.

The first mesh piconet coordinator (MPNC 1) 211 analyzes the received data frame to transmit the data frame to the third mesh piconet coordinator (MPNC 3) 219 that is a mesh piconet coordinator of the third piconet 230 including a destination mesh device.

The third mesh piconet coordinator (MPNC 3) 219 analyzes the received data frame to transmit the data frame to the eleventh mesh device (MDEV 11) 235, a destination mesh device.

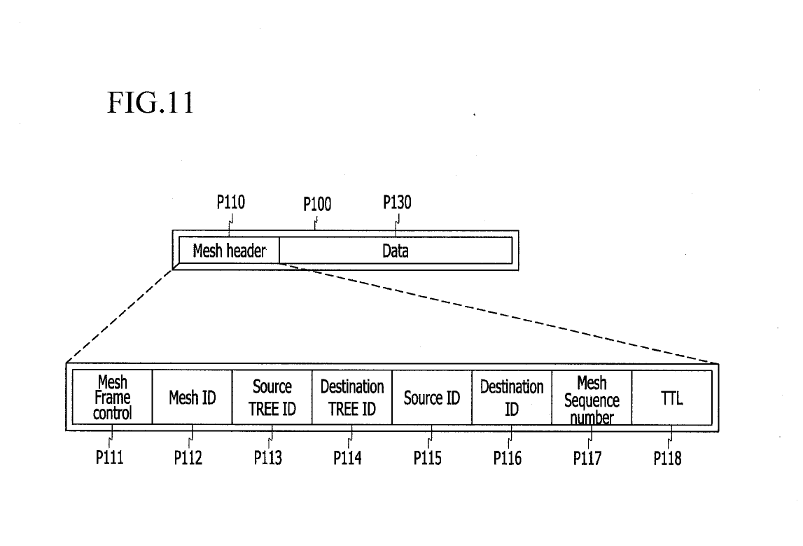

Referring to FIG. 11, a structure of a data frame configured by a mesh device included in a wireless personal area network (WPAN) according to an exemplary embodiment of the present invention will now be described.

FIG. 11 shows a structure of a data frame configured by a mesh device according to an exemplary embodiment of the present invention.

As shown in FIG. 11, the data frame P100 includes a mesh header P110 including data transmission information and data P130 to be transmitted.

The mesh header P110 includes a mesh frame control field P111, a mesh ID field P112, a source tree ID field P113, a destination tree ID field P114, a source ID field P115, a destination ID field P116, a mesh sequence number field P117, and a time to line (TTL) field P118.

The mesh frame control field P111 determines a data frame transmission method and a transmission frame type.

The mesh ID field P112 indicates a corresponding mesh ID.

The source tree ID field P113 shows a tree ID of a source mesh piconet coordinator.

The destination tree ID field P114 represents a tree ID of a destination mesh piconet coordinator.

The source ID field P115 is a device ID of a source mesh device.

The destination ID field P116 shows a device ID of a destination mesh device.

The mesh sequence number field P117 indicates a mesh sequence number for maintaining a frame transmission order and preventing repeated transmission.

The time to line field P118 represents the maximum number of hops allowable during data frame transmission.

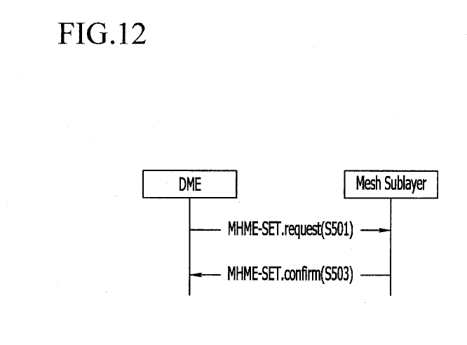

Referring to FIG. 12, a message flow in the mesh network communication device (hereinafter a device) 100 when the device 100 sets a specific parameter of a personal area network information base (FIB) with a specific value will now be described. Here, the device 100 can follow FIG. 4.

FIG. 12 shows a method for setting a parameter of a PIB according to an exemplary embodiment of the present invention.

As shown in FIG. 12, the DME 113 of the device 100 transmits the MHME-SET.request primitive to the mesh sublayer 135 so as to request to set a specific parameter of the PIB with a specific value (S501).

The mesh sublayer 135 transmits the MHME-SET.confirm primitive for notifying the result of setting a specific parameter of the PIB with a specific value to the DME 113 according to the received MHME-SET.request primitive (S503). In this instance, the mesh sublayer 135 can set the specific parameter of the PIB of each layer with a specific value by using the primitive of one of the MAC sublayer 155 and the physical layer 175.

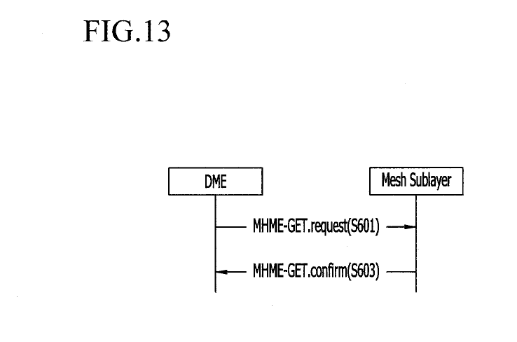

Referring to FIG. 13, a message flow in the mesh network communication device (hereinafter the device) 100 when the device 100 requests a current value of the specific parameter of the personal area network information base (FIB) will now be described. Here, the device 100 can follow FIG. 4.

FIG. 13 shows a method for requesting a parameter of a PIB according to an exemplary embodiment of the present invention.

As shown in FIG. 13, the DME 113 of the device 100 transmits the MHME-GET.request primitive to the mesh sublayer 135 so as to request the current value of the specific parameter of the PIB (S601).

The mesh sublayer 135 transmits the MHME_GET.confirm primitive including the current value of the specific parameter of the PIB to the DME 113 according to the received MHME-GET.request primitive (S603). In this instance, the mesh sublayer 135 can check the PIB of each layer by using the primitive of one of the MAC sublayer 155 and the physical layer 175.

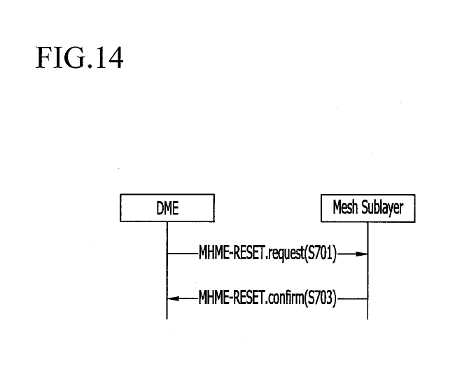

Referring to FIG. 14, a message flow in the mesh network communication device (hereinafter the device) 100 when the device 100 resets the parameter of the personal area network information base (FIB) will now be described. In this instance, the device 100 can follow FIG. 4.

FIG. 14 shows a method for resetting a parameter of a PIB according to an exemplary embodiment of the present invention.

As shown in FIG. 14, the DME 113 of the device 100 transmits the MHME-INITIALIZE.request primitive for requesting to maintain the parameter of the PIB at a default value or a current state value to the mesh sublayer 135 (S701).

The mesh sublayer 135 transmits the MHME-INITIALIZE.confirm primitive including the result of resetting the parameter of the PIB to the DME 113 according to the received MHME-INITIALIZE.request primitive (S703). In this instance, the mesh sublayer 135 can reset the PIB of each layer by using the primitive of one of the MAC sublayer 155 and the physical layer 175.

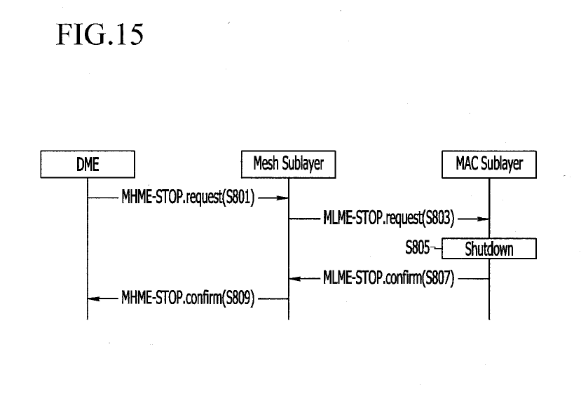

Referring to FIG. 15, a message flow in the mesh network communication device (hereinafter the device) 100 that is a mesh piconet coordinator (MPNC) when the device 100 dissociates the mesh network will now be described. In this instance, the device 100 can follow FIG. 4.

FIG. 15 shows a message flow when dissociating from a mesh network according to an exemplary embodiment of the present invention.

As shown in FIG. 15, the DME 113 of the device 100 transmits the MHME-STOP.request primitive to the mesh sublayer 135 so as to perform a mesh network dissociation process (S801).

The mesh sublayer 135 transmits the MLME-STOP.request primitive to the MAC sublayer 155 according to the received MHME-STOP.request primitive (S803).

The MAC sublayer 155 performs a shutdown process according to the received MLME-STOP.request primitive (S805).

The MAC sublayer 155 transmits the MLME-STOP.confirm primitive to the mesh sublayer 135 according to the shutdown process result (S807).

The mesh sublayer 135 transmits the MHME-STOP.confirm primitive to the DME 113 according to the received MLME-STOP.confirm primitive to notify the DME 113 of the shutdown result of the mesh network (S809).

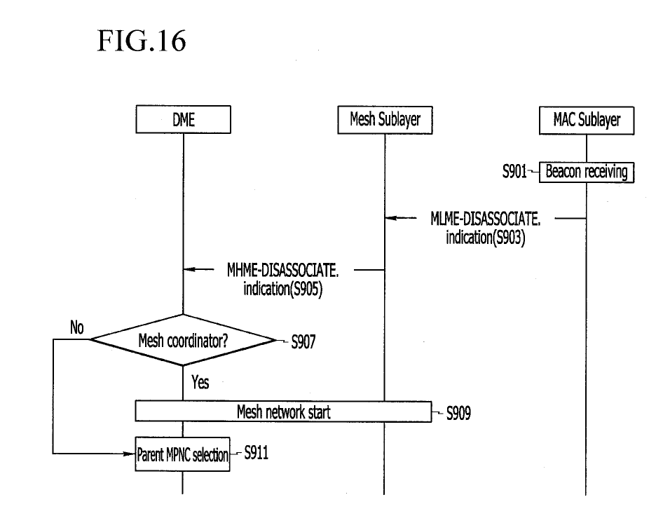

Referring to FIG. 16, a message flow in the mesh network communication device (hereinafter the device) 100 that is a child mesh piconet coordinator (MPNC) when the device 100 dissociates the mesh network according to a mesh network shutdown instruction of the parent MPNC will now be described. Here, the device 100 can follow FIG. 4.

FIG. 16 shows a message when dissociating a mesh network according to another exemplary embodiment of the present invention.

As shown in FIG. 16, the MAC sublayer 155 of the device 100 receives a beacon including a piconet coordinator shutdown information element (PNC Shutdown IE) from the parent MPNC (S901).

The MAC sublayer 155 transmits the MLME-DISASSOCIATE.indication primitive including a device ID (DEVID) and a device address (DEVAddress) of the parent MPNC to the mesh sublayer 135 (S903).

The mesh sublayer 135 transmits the MHME-DISASSOCIATE.indication primitive including a device ID (DEVID) and a device address (DEVAddress) of the parent MPNC to the DME 113 according to the received MLME-DISASSOCIATE.indication primitive (S905).

The DME 113 determines whether the parent MPNC having transmitted the corresponding beacon is a mesh coordinator according to the received MHME-DISASSOCIATE.indication primitive (S907). In this instance, the mesh coordinator represents the highest parent MPNC of the mesh network. For example, when the mesh network follows FIG. 10, the mesh network becomes the first mesh piconet coordinator (MPNC 1) 211.

When the parent MPNC is a mesh network, the DME 113 and the mesh network 135 start the mesh network with a mesh coordinator of a new mesh network (S909).

When the parent MPNC is not a mesh network, the DME 113 selects another parent MPNC to associate the mesh network (S911).

According to the embodiment of the present invention, under the WPNA environment with a plurality of piconets, an inter-piconet high-speed multi-hop communication function is provided by allowing a tree-based routing service and an optimized routing service by defining a mesh sublayer and a mesh sublayer management entity and defining a primitive for each service access point.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for starting a mesh network by a device including a DME (device management entity), a mesh sublayer and a MAC (medium access control) sublayer, the method comprising:
receiving, by the mesh sublayer, a first scan request primitive for requesting a scan process to search for a mesh network from the DME;
transmitting, by the mesh sublayer, a second scan request primitive for requesting the scan process to the MAC sublayer;
receiving, by the mesh sublayer, a first scan confirm primitive for reporting a result of the scan process from the MAC sublayer;
transmitting, by the mesh sublayer, a second scan confirm primitive including information about the mesh network to the DME;
receiving, by the mesh sublayer, a first start request primitive for starting the mesh network from the DME;
transmitting, by the mesh sublayer, a second start request primitive for starting a piconet to the MAC sublayer;
receiving, by the mesh sublayer, a first start confirm primitive for indicating a result of a beacon preparation process from the MAC sublayer; and
transmitting, by the mesh sublayer, a second start confirm primitive for indicating the result of the beacon preparation process to the DME.

2. The method of claim 1, wherein the information about the mesh network includes an ID of the piconet.

3. The method of claim 1, wherein the first start request primitive includes an ID of the mesh network to be started.

4. The method of claim 1, further comprising:
transmitting, by the mesh sublayer, a mesh capability request primitive including a parameter for a mesh piconet coordinator (MPNC) initialization to the MAC sublayer after receiving the first start request primitive; and
receiving, by the mesh sublayer, a mesh capability confirm primitive from the MAC sublayer according to a result of the MPNC initialization.

5. The method of claim 4, wherein the MAC sublayer enters an MPNC operation mode and initializes the parameter.

6. The method of claim 1, wherein the MAC sublayer starts the piconet after receiving the second start request primitive.

7. The method of claim 1, further comprising:
receiving, by the mesh sublayer, a first stop request primitive for starting a shutdown process of the mesh network from the DME;
transmitting, by the mesh sublayer, a second stop request primitive for requesting the shutdown process to the MAC sublayer;
receiving, by the mesh sublayer, a first stop confirm primitive for indicating a result of the shutdown process from the MAC sublayer; and
transmitting, by the mesh sublayer, a second stop confirm primitive for reporting the result of the shutdown process to the DME.

8. A method for forming a tree in a mesh network by a device including a DME (device management entity), a mesh sublayer and a MAC (medium access control) sublayer, the method comprising:
receiving, by the mesh sublayer, a first scan request primitive for requesting a scan process to search for a mesh network from the DME;
transmitting, by the mesh sublayer, a second scan request primitive for requesting the scan process to the MAC sublayer;
receiving, by the mesh sublayer, a first scan confirm primitive for reporting a result of the scan process from the MAC sublayer;
transmitting, by the mesh sublayer, a second scan confirm primitive including information about the mesh network to the DME;
receiving, by the mesh sublayer, a first associate request primitive from the DME, according to a selection of a parent mesh piconet coordinator (MPNC) with which to associate;
transmitting, by the mesh sublayer, a second associate request primitive for requesting a piconet association process to the MAC sublayer;
receiving, by the mesh sublayer, a tree ID assign request primitive for requesting an assignment of a tree ID from the DME;
receiving, by the mesh sublayer, the tree ID from the parent MPNC; and
transmitting, by the mesh sublayer, a tree ID assign confirm primitive including the tree ID to the DME.

9. The method of claim 8, further comprising:
receiving, by the mesh sublayer, a first start request primitive for starting a generation process of a child piconet from the DME;
transmitting, by the mesh sublayer, a second start request primitive to the MAC sublayer;
receiving, by the mesh sublayer, a first start confirm primitive for indicating a result of a beacon preparation process from the MAC sublayer; and
transmitting, by the mesh sublayer, a second start confirm primitive for indicating the result of the beacon preparation process to the DME.

10. The method of claim 9, further comprising:
transmitting, by the mesh sublayer, a mesh capability request primitive including a parameter for a child MPNC initialization to the MAC sublayer after receiving the first start request primitive; and
receiving, by the mesh sublayer, a mesh capability confirm primitive from the MAC sublayer according to a result of the child MPNC initialization.

11. The method of claim 10, wherein the MAC sublayer enters an MPNC operation mode and initializes the parameter to operate as the child MPNC.

12. The method of claim 8, further comprising:
receiving, by the mesh sublayer, a first associate confirm primitive for indicating a result of the piconet association process from the MAC sublayer after transmitting the second associate request primitive; and
transmitting, by the mesh sublayer, a second associate confirm primitive for reporting the result of the piconet association process to the DME.

13. The method of claim 8, wherein the DME selects the parent MPNC among a plurality of MPNCs based on the information included in the second scan confirm primitive.

14. The method of claim 8, further comprising:
receiving, by the mesh sublayer, a first disassociate indication primitive including a device ID and a device address of the parent MPNC from the MAC sublayer, according to a shutdown request from the parent MPNC; and
transmitting, by the mesh sublayer, a second disassociate indication primitive including the device ID and the device address of the parent MPNC to the DME.

15. The method of claim 14, further comprising
starting, by the DME, a new mesh network a mesh coordinator of the new mesh network if the parent MPNC is a mesh coordinator.

16. The method of claim 14, further comprising
selecting, by the DME, a new parent MPNC to associate the mesh network if the parent MPNC is not a mesh coordinator.

17. The method of claim 14, further comprising
receiving, by the MAC sublayer, the shutdown request by receiving a beacon including a piconet coordinator shutdown information element (PNC Shutdown IE) from the parent MPNC.

18. A method of dissociating a mesh network by a child mesh piconet coordinator (MPNC) including a DME (device management entity), a mesh sublayer and a MAC (medium access control) sublayer, the method comprising:
receiving, by the MAC sublayer, a beacon including a piconet coordinator shutdown information element (PNC shutdown IE) from a parent MPNC;
receiving, by the mesh sublayer, a first disassociate indication primitive including a device ID and a device address of the parent MPNC from the MAC sublayer, according to the PNC shutdown IE;
transmitting, by the mesh sublayer, a second disassociate indication primitive including the device ID and the device address of the parent MPNC to the DME;
determining, by the DME, whether the parent MPNC is a mesh coordinator or not; and
performing, by the DME, a dissociation process according to a determination result.

19. The method of claim 18, further comprising
starting, by the DME, a new mesh network a mesh coordinator of the new mesh network if the parent MPNC is a mesh coordinator.

20. The method of claim 18, further comprising
selecting, by the DME, a new parent MPNC to associate the mesh network if the parent MPNC is not a mesh coordinator.
